(19) United States
(12) Patent Application Publication
(10) Pub. No.: US 2023/0106146 A1
(43) Pub. Date: Apr. 6, 2023

(54) Multi-layered plastic casing having a porous food contact side, suitable for transferring food additives

(71) Applicant: Kalle GmbH, Wiesbaden (DE)

(72) Inventors: Igor RASKITA, Wiesbaden (DE); Martina KÖNIG, Wiesbaden (DE); Ulrich DELIUS, Trittau (DE); Hans FÜßER, Münster (DE); Michael SCHMIDT, Oestrich-Winkel (DE)

(73) Assignee: Kalle GmbH, Wiesbaden (DE)

(21) Appl. No.: 17/959,353

(22) Filed: Oct. 4, 2022

(30) Foreign Application Priority Data
Oct. 4, 2021 (DE) 10 2021 125 656.9

(51) Int. Cl. A22C 13/00; B32B 1/08; B32B 5/18; B32B 5/32; B32B 27/08; B32B 27/32; B32B 27/06; B32B 7/12; B32B 27/18; B29C 48/00; B29C 48/10; B29C 48/21; B29C 48/91; B29C 48/88

(52) U.S. Cl. CPC A22C 13/0013; B32B 1/08; B32B 5/18; B32B 5/32; B32B 27/08; B32B 27/32; B32B 27/065; B32B 7/12; B32B 27/18; B29C 48/022; B29C 48/10; B29C 48/21; B29C 48/0018; B29C 48/9105; B29C 48/912; B32B 2264/104; B32B 2307/732; B32B 2250/05; B32B 2264/0264; B32B 2307/7246; B32B 2597/00; B29K 2077/00

(57) ABSTRACT

A coextruded, multi-layered, water vapor-impermeable, tubular, and seamless food casing having at least three layers is provided. The layers include at least one porous layer having a porous food contact side suitable for transferring food additives having a porous food contact side, at least one carrier layer based on at least one aliphatic and/or partially aromatic (co-)polyamide, and at least one water vapor-impermeable layer. At least one adhesive layer including an adhesion-promoting component is arranged between the adjoining layers or an adhesion-promoting component is contained in one or more of the water vapor-impermeable layer(s). At least one porous layer includes an aliphatic (co-)polyamide and a hydrophilic (co-)polymer having a mean molar mass M_{w} of at least 8000 Da. A method for producing the food casing is provided. The food casing is used as an artificial sausage casing, especially, for cooked or boiled sausage.

### CROSS-REFERENCE TO RELATED APPLICATIONS

This application claims priority to German Patent Application 10 2021 125 656.9 filed Oct. 4, 2021, which is hereby incorporated herein by reference in its entirety.

### FIELD OF THE INVENTION

The invention relates to a coextruded, multi-layered, water vapor-impermeable, tubular, and seamless food casing having one or more porous layers, which is capable of efficiently absorbing, storing, and transferring food additives to a filling material in contact with the inner side. In addition, it relates to a method for producing the casing and its use as a food package.

### BACKGROUND OF THE INVENTION

A multilayer food casing having at least one porous layer is known in the prior art. WO 2017/148682 A1 describes a tubular, coextruded film consisting of three “layer packages”. The inner “layer package” consists of multiple layers adjoining one another, which each consist of a foamed polymer of the type polyolefin. The inner layers are always based on polyolefin, especially at least one olefinic polymer, copolymer, or terpolymer, in particular from the group LDPE, LLDPE, VLDPE and mixtures thereof, especially copolymers and terpolymers with C3-C10 alpha-olefins or alkyl(meth)acrylates. The outer package consists of multiple layers, each of the type polyamide. An adhesion-promoting layer is located between these layer packages. The cavities or open cells or pores in the layers of the “inner package” are produced during the coextrusion via added foaming agent. Chemical foaming agents are preferred, especially alkali (bi)carbonates and citric acid. The inner side of the film is capable of dispensing or transferring food additives.

A multilayer food casing having a porous layer is known from EP 3 014 997 A1. The prior art describes a coextruded food casing having at least the following three layers:
at least one inner porous layer,
at least one barrier layer (i.e., a layer having a barrier effect for water vapor and/or oxygen),
at least one adhesive layer,
   wherein the porosity of the first-mentioned layer is created by (co-)extruding a polymer composition and a supercritical pore former. The porous layer is capable of absorbing, fixing, and desorbing at least one functional (food) additive and transferring it to the encased food. Various gases in the supercritical state are defined as supercritical pore formers. Carbon dioxide (CO₂) and nitrogen (N₂) are preferred. The porous layer itself preferably contains an organic polymer, particularly preferably a polymer of the groups (co-)polyamides, polyolefins, vinyl copolymers, vinylidene copolymers, and (co-)polyesters. The introduction of the supercritical pore former into the layer-forming polymer takes place via one or more access openings on the extruder; preferably via an extruder section having a plurality of radially distributed injection nozzles. A method design with arrangement of the access opening(s) above a mixing section of the extruder is also preferred, where its screw contains screw blades having multiple perforations.

EP 1 911 352 A1 describes a coextruded, multi-layered stretched casing having a porous inner layer. The inner layer preferably contains at least one plastic component and at least one agent which assists the formation of pores or pore channels during the stretching. The inner layer preferably additionally contains a (liquid) emulsifier and a fine-grain organic and/or inorganic filler. Furthermore, a mineral oil is preferred as a component of the inner layer. The plastic component is typically an organic thermoplastic polymer; this is preferably from the group of aliphatic or partially aromatic (co-)polyamides, polyolefins, polyurethanes, vinyl polymers, vinylidene chloride (co-)polymers, and (co-)polyesters. The porous layer is also capable of absorbing, fixing, and desorbing at least one functional (food) additive and transferring it to the encased food.

DE 10 2008 017 920 A1 describes in a similar manner a casing which is capable of fixing a colorant-containing and/or flavouring-containing liquid on the inside. The inner layer is not porous, but rather formed like a relief. The relief elements are specified with respect to length and volume. Example 6 describes a 5-layer casing in which a combination of polyamide 6 and a propellant superconcentrate (masterbatch having substances which thermally split off gases) was used for the inner layer.

Finally, WO 2005/097461 A1 discloses a coextruded, at least two-layer casing having an outer layer which has a porosity of at least 5 vol.-% and a roughness R_{z} of at least 5.0 μm. The surface of the outer layer has open pores and/or pores having edges protruding like a crater on the surface. These pores cause a matte appearance on the outside of the casing, which can be made very similar to that of fibre casing, fibre-reinforced cellulose casing, or natural casing. The creation of the surface structure of the outer layer takes place in one of the embodiments by way of physical or chemical foaming of a plastic melt. Of the two, chemical foaming by means of substances which split off gas in the heat (for example sodium hydrogen carbonate) is preferred.

The polymers known from WO 2017/148682 A1 are consistently very nonpolar or hydrophobic and thus have very low affinity to polar media such as a protein-containing meat emulsion. No adhesion forms between the coagulated meat surface and the casing upon heating of such emulsions in casings. Accordingly, water contained in the emulsion can separate at the interface between meat and casing (so-called “purge” or jelly layer).

A further disadvantage caused by the non-polarity of the polyolefinic layer materials is the low permeability thereof to polar media. In the absorption and desorption of typical aqueous polar food additives (liquid smoke, colorants, and flavours) or the formulations thereof, a transport between the cavities can only take place in so far as the latter communicate with one another (thus through channels or the like) and are connected to one another. Water or polar materials travel between cavities isolated from one another, thus through the matrix, extremely slowly. Of the cavities of the “layer package”, only those are thus used for the absorption and desorption which are located directly at the inner surface of the casing or are connected via “channels” to cavities located at the inner surface. The transfer function of the casing is therefore not efficient.

Finally, the non-polarity of the polyolefinic layer surface is disadvantageous for the uniformity of the absorption of polar or aqueous food additives (food additive materials). The latter tend to drip off of the surface or flow together spontaneously to form droplets. Therefore, in the case of short contact time with the food additive between coating and drying, the surface is not uniformly occupied and the additive is not completely absorbed at least in the open pores of the foam structure. In the case of coloured additives, in the filled food, a blotchy, pale colour impression can result on its surface therefrom.

The subject matter of DE 10 2004 017 350 A1 is a multi-layered coextruded, seamless food casing made of thermoplastic material. The outer layer has a porosity of at least 5 vol.-% and a roughness on its surface of at least 5 μm. The casing thus has a matte appearance, similarly to that of natural casings or casings based on regenerated cellulose. To create the porosity, a propellant, such as sodium hydrogen carbonate, and/or a propellant gas is added to the material of the outer layer before the extrusion, which results in pores or bubbles in the material upon depressurization.

A multi-layered, coextruded, seamless tubular food casing having at least one porous inner layer is disclosed in EP 3 014 997 A1. According to EP 3 014 997 A1, the porosity of the inner layer(s) is created by a supercritical pore former, which is added immediately before the extrusion. “Supercritical pore former” implies that a medium that is gaseous under normal conditions (for example CO₂ or N₂) is provided, put into a supercritical state by application of high pressure and low temperature, and introduced into a plastic melt in such a way that it forms pores therein by expansion. This principle is known as the physical foaming of plastics.

The physical foaming process has the disadvantage of the unusually high expenditure for method technology. Compression and temperature control of the medium used for foaming are required to generate the supercritical state. A special, complex extruder having diverse, radially arranged injection nozzles and a mixing segment along the extruder screw having elements perforated multiple times (“flights”) is preferably required for the fine distribution of the supercritical medium in the melt.

According to EP 3 014 997 A1, the following are suitable for the porous inner layer: (co-)polyamides, polyolefins, vinyl copolymers (such as polyvinyl alcohol, ethylene/vinyl alcohol copolymers, polyvinyl pyrrolidone, polystyrene, polyvinyl chloride and/or polyvinyl fluoride), vinylidene chloride copolymers or (co-)polyesters (such as polylactides, polycaprolactone, polycarbonate, or copolymers of dials with aliphatic or aromatic dicarboxylic acids). Ethylene and propylene copolymers and polyolefins grafted with maleic acid anhydride are designated as particularly suitable. Furthermore, they can contain a nucleation agent. The proportion of the possibly provided nucleation agent is not mentioned. Among others, carbonates, such as sodium carbonate, and azo compounds, such as azodicarbonamides, are mentioned as nucleation agents. In addition, the multi-layered casing according to EP 3 014 997 A1 can have layers which consist in a significant part of aliphatic and/or partially aromatic (co-)polyamide. However, solely multi-layered casings having a foamed inner layer made of an ethylene/butylene copolymer (C4-LLDPE) and a filler masterbatch made of talcum and LLDPE—without nucleation agents or other additives—are specifically disclosed in the examples.

EP 1 911 352 A1 describes, as a component of the coextruded, inner layer, preferably an emulsifier and an oil. These materials are very runny or significantly runnier at the temperatures of the extrusion than the organic polymer forming the matrix. It is known that mixtures of viscous and runny media tend toward separation under the shear rate which is present in the nozzle dap of an extrusion nozzle. Specifically, the runnier medium travels in the direction of the greatest shear rate, thus in the direction of the gap surfaces (in coextrusion in the direction of the inner gap surface). The consequence is an enrichment of the medium at the inner surface of the coextruded material, followed by successive deposition at the nozzle edge. The deposits have to be regularly removed to avoid disturbances during the tube formation. The efficiency of the production process is thus impaired.

The casing according to DE 10 2008 017 290 A1 does not contain any cavities or pores, but rather only a relief-type formation of the inside layer. This layer thus has a slightly enlarged “outer surface”, but not the much larger “inner surface” and no inner volume, as is present in porous structures. Accordingly, the casing can only absorb and transfer food additives to a limited extent.

WO 2005/097461 A1 describes a multi-layered casing having a porous outer layer. The porosity results in a matte appearance of the outside. A food transfer function is not possible due to the location of the porous layer and is not intended.

### SUMMARY OF ADVANTAGEOUS EMBODIMENTS OF THE INVENTION

It is an object of the present invention to provide a (barrier) casing based on thermoplastics, which does not have the above-described disadvantages of the prior art. In particular, the casing is to have the capability of rapid, uniform, and high absorption of food additives, and the storage and efficient transfer there of to a filling material packed in the casing.

The object was achieved by a coextruded, tubular, water vapor-impermeable, and seamless casing having at least three layers. At least one layer is porous and forms a surface layer that faces toward a food. At least one porous layer comprises an aliphatic (co-)polyamide and a hydrophilic (co-)polymer having a mean molar mass M_{w} of at least 8000 Da (determined via GPC=gel permeation chromatography), wherein the proportion of the hydrophilic (co-)polymer in the porous layer is 3 to 40 wt. %, in relation to the total weight of the respective porous layer. The at least one porous layer is capable of efficiently absorbing, storing, and transferring food additives.

The invention also includes a corresponding production method, in which the porosity of said layer(s) is produced by the use of one or more chemical propellants. Chemical propellants refers to organic or inorganic substances (e.g., citric acid, azodicarbonamide, sodium hydrogen carbonate), which split off one or more substance(s) gaseous in normal conditions (e.g., CO₂ or N₂) at elevated temperature. The production method optionally also includes biaxial stretching of the casing, preferably in a so-called double-bubble or triple-bubble process. The mechanical strength and elasticity of the casing is significantly increased by the biaxial stretching. Supercritical pore formers, such as supercritical CO₂ or supercritical nitrogen, are not used in the present invention. They are significantly more difficult to meter and to mix with the other components of the inner layer than chemical propellants.

### DETAILED DESCRIPTION OF ADVANTAGEOUS EMBODIMENTS OF THE INVENTION

In one embodiment, the casing has a porous layer which is arranged on the surface of the casing facing toward the food. However, embodiments having two, three, or more adjoining porous layers are preferred, of which one forms the surface facing toward the food.

“Water vapor-impermeable” is understood in the context of the present invention as a casing which has a permeability to water vapor of less than 30 g/m² d, preferably less than 15 g/m² d, determined according to DIN 53 122, part 1 at 23° C. and 85% relative humidity. For this purpose, a casing section, which is stretched over a shell containing a desiccant to form a seal, is subjected on one side in the climate chamber with stationary air to air having a relative humidity of 85% at 23° C. The weight of the entire shell including casing, desiccant, and sealing wax is determined before and after the stay in the climate chamber.

The term “porous layer” refers in the meaning of the invention to a plurality of cavities (so-called openings) connected to one another, in particular pores, which are capable of efficiently absorbing, storing, and transferring the food additives.

The overall porosity of the one porous layer is generally in the range of 5 to 30 vol. %, determined according to the method described below (“volumetric porosity determination”). In the case of multiple adjoining porous layers, their porosity is preferably also in the range of 5 to 80 vol. % or the porosity averaged over the multiple porous layers is in the range of 5 to 80%. Corresponding porosity values in the range of 10 to 75 vol. % are preferred, particularly preferably 20 to 70 vol. %, particularly preferably in the range of 30 to 65 vol. %.

The main component of the at least one porous layer is at least one aliphatic (co-)polyamide.

The term “(co-)polyamide” is used in conjunction with the present invention as an abbreviated name for “polyamide or copolyamide” The term “copolyamide” also includes polyamides having three or more different monomer units here.

Of the aliphatic (co-)polyamides, poly(ε-caprolactam), also referred to as PA 6, copolymers of ε-caprolactam and ω-laurin lactam (=PA 6/12), copolymers of ε-caprolactam, hexamethylene diamine, and adipic acid (=PA6/66) and terpolymers of ε-caprolactam, 3-aminomethyl-3,5,5-trimethylcyclohexylamine (isophorone diamine) and isophthalic acid are preferred. The (co-)polyamides also include heterofunctional polyamides, in particular polyether amides, polyester amides, polyether ester amides, and polyamide urethanes. Among these polymers, those having block-like distribution of the different functionalities, i.e., block copolymers, are preferred. Particularly preferred block copolymers are poly(ether block amides).

The proportion of the aliphatic (co-)polyamide is generally 50 to 95 wt. %, preferably 60 to 85 wt. %, particularly preferably 70 to 80 wt. %, each in relation to the total weight of the respective porous layer.

A further component of the at least one porous layer is at least one hydrophilic (co-)polymer having a mean molar mass M_{w} of at least 8000 Da. Of these, the following are preferred:

a) polyvinyl alcohol (PVAL), as is obtainable by partial or complete saponification of polyvinyl acetate (PVAC), or a copolymer having vinyl alcohol units (for example a copolymer having units made up of vinyl alcohol and propene-1-ol),
b) polyvinyl pyrrolidone (homopolymer N-vinyl-2-pyrrolidone),
c) copolymers having N-vinyl-2-pyrrolidone units and units of at least one α,β-olefinically unsaturated monomer, preferably vinyl ester, particularly preferably vinyl acetate,
d) copolymers of N-vinyl-2-pyrrolidone and one or more α,β-unsaturated carboxylic acids and/or one or more esters or amides of α,β-unsaturated carboxylic acids, preferably methyl acrylate and acrylamide,
e) copolymers of N-vinyl-2-pyrrolidone and N-vinyl-imidazole.

Of these groups, b) and d) are particularly preferred. Polyvinyl pyrrolidone having a mean molar mass M_{w} in the range of 8500 to 400 000 Da and a K value (according to Fickentscher) in the range of 15 to 60 is especially preferred. The mean molar mass M_{w} of the polyvinyl pyrrolidone is preferably 9700 to 200 000 Da, particularly preferably 24 000 to 70 000 Da.

The proportion of the hydrophilic (co-)polymer in the mixture is generally 3 to 40 wt. %, preferably 8 to 25 wt. %, particularly preferably 10 to 20 wt. % in relation to the total weight of the respective porous layer.

For the foaming of the at least one porous layer, at least one chemical propellant is added as a further component during the extrusion. Citric acid and/or sodium hydrogen carbonate are preferred among these. The chemical propellants decompose partially or entirely at the temperatures of the extrusion to form smaller molecules, of which at least one is gaseous under normal conditions. The finished casing therefore no longer contains the added propellant(s) in the original state (possibly still in reduced concentration), but rather in the form of its decomposition products. These may be detected in the finished casing in a corresponding amount. These are materials that are gaseous under normal conditions, additionally also liquid and/or solid. The gaseous decomposition products cause the foaming. This means that they result in the formation of bubbles or foam cells in the melt. Liquid decomposition products can possibly also be gaseous at extrusion temperature and contribute to the foaming. In the case of sodium hydrogen carbonate, CO₂ results as the gas. Sodium carbonate and water remain as further decomposition products. Citric acid splits off water and CO₂ step-by-step, Itaconic acid anhydride and citraconic acid anhydride remain. The amount of chemical propellant is selected so that the abovementioned porosity of the inner layer(s) is achieved.

The at least one porous layer optionally contains inorganic or organic additives in a proportion of 0.2 to 5 wt. % in relation to the total weight of the respective layer. Examples of these are nucleation agents (e.g., CaCO₃, BaSO₄, or talcum), softeners, plasticizing agents, among them diols (for example polyethylene glycol) and/or polyols (for example glycerine), further plastic-typical additives such as anti-blocking and slip agents, pigments, and stabilizers.

The term “polyol” stands for an aliphatic compound having three or more free hydroxy groups, for example, glycerine, diglycerine, 1,1,1-trimethylolpropane, 2,2-bishydroxymethyl-1,3-propanedol (pentaerythritol), furthermore sugar alcohols such as erythritol, sorbitol, and mannitol. Of these, glycerine is preferred.

The hydrophilic polymer having a molar mass M_{w} of at least 8000 Da has two positive effects in the mixture with aliphatic (co-)polyamide:

1. Increasing the water swellability of the foam matrix; water applied to the foam surface and substances dissolved in water can thus diffuse in an accelerated manner through the cell walls of the bubbles and distribute themselves rapidly within the foam structure. Rapid “drying on” or immobilization of a layer made of aqueous food additives applied to the casing surface is advantageous.

2. In relation to pure (co-)polyamide (with molar mass in the extrusion-typical range), it causes a significant increase of the melt strength. Melt strength is understood in this context as a progressive resistance of a melt with respect to rapid deformations. The deformation resistance is mathematically described as the so-called extensional viscosity v_{ε} and can be measured using special rheometers. The higher these values are, the “stronger” is the melt. High melt strength causes a slowed, controlled expansion of the gas bubbles arising during the foaming and a strength increase of the “cell walls” between adjoining bubbles. Under this condition, it is possible to obtain particularly fine foam structures having bubbles or pores of relatively uniform size.

There are many options in principle for determining the porosity of foamed layer(s). The pore surface areas can thus be ascertained on microscopic images of cross sections (produced by microtome) of the casing by statistically measuring the cavity edges, preferably by means of a grid made up of auxiliary lines, which is laid over the microscopic image. By combining the area values of cross sections produced in multiple directions, the total porosity may be calculated as a ratio of cavity volume to total volume (geometric volume).

Porosity in the meaning of the present invention is the sum of “open porosity” (represented by pores which are connected to one another via channels and with the surroundings) and “closed porosity” (represented by closed, non-connected pores). At smaller pore sizes, the method of mercury infiltration is suitable for determining the open porosity. In the case of larger pores, as occur in the casing according to the present invention, however, the mentioned methods are inaccurate or unsuitable. A method of “volumetric porosity determination” has proven to be suitable for determining the total porosity Φ according to the following definition:

Φ=(V_{H}/V)×100 [%]=((V−V_{F})/V)×100 [%]

with V_{H}=cavity volume,
V_{F}=pure volume, and
V=total volume of the sample body

To determine Φ, V_{F} and V are ascertained as follows. V_{F} corresponds to the volume of a “pore-free” extruded layer made of solid raw materials. This volume can be ascertained on the basis of the density of the (unfoamed) extruded material and the speed of the extruder used or the speed of the melt pump downstream from the extruder, if a throughput calibration of extruder or pump was performed on the raw material mixture. Alternatively, V_{F} can also be ascertained on the finished casing, in that its foamed layer is selectively dissolved using a suitable solvent (for example formic acid), the solution obtained is evaporated, and the dry residue is weighed. The total volume V of the foamed layer is ascertained via its average thickness, obtained by measuring casing cross sections produced via microtome by converting the thickness value to a volume. The method is referred to in the present application as “volumetric porosity determination”.

The casing contains at least one layer based on at least one aliphatic and/or partially aromatic (co-)polyamide. Of the aliphatic (co-)polyamides, poly (ε-caprolactam), also referred to as PA 6, copolymers of ε-caprolactam and ω-laurin lactam (=PA 6/12), copolymers of ε-caprolactam, hexamethylene diamine, and adipic acid (=PA6/66) and terpolymers of ε-caprolactam, 3-aminomethyl-3,5,5-trimethylcyclohexylamine (isophorone diamine), and isophthalic acid are preferred. Of the partially aromatic (co-)polyamides, copolymers of hexamethylene diamine, isophthalic acid, and terephthalic acid (PA 6-I/6-T) and the homopolymer of m-xylylene diamine and adipic acid (nylon-MXD6) are preferred. The layer optonally contains plastic-typical additives in relatively small quantities. The proportion of the additives is 0.1 to 5 wt. %, preferably 0.2 to 4 wt. %, particularly preferably 0.7 to 3 wt. %, particularly preferably 1 to 2 wt. %, in relation to the total weight of the respective layer. The preferred additives are anti-blocking and/or slip agents, stabilizers, and colour pigments.

The casing contains at least one layer having water vapor-blocking (water vapor-impermeable) character. The layer preferably predominantly comprises olefinic (co-)polymers, for example, polyethylene (HDPE, LDPE, or LLDPE), ethylene-α-olefin copolymers, polypropylene, ethylene-propylene copolymers, terpolymers of various olefins. Heterofunctional olefin copolymers can also be proportionally included. Examples of these are copolymers of ethylene and vinyl acetate or ethylene and (meth) acrylic acid and corresponding functional terpolymers. This layer also optionally contains relatively small quantities of plastic-typical additives, among them anti-blocking and/or slip agents, stabilizers, and colour pigments.

The casing contains at least one layer which is arranged adjoining layers based on polyamide and is capable of forming chemical and/or physical adhesive properties (so-called adhesive layer). This layer preferably predominantly contains olefin-containing polymer, which is modified using polar functional groups. Examples of this are polyethylene (or ethylene-α-olefin copolymer) grafted with anhydride of an α,β-unsaturated dicarboxylic acid (preferably maleic acid anhydride), ethylene/vinyl acetate copolymers, ethylene/(meth)acrylic acid copolymers and their Na or Zn salts, ethylene/(meth)acrylic acid ester copolymers and corresponding terpolymers. Among others, non-functionalized olefin (co-)polymers can be included as the admixture.

One or more of the layer(s) having water vapor-blocking character and the layer(s) having adhesive properties comprising an adhesion-promoting component can also be combined to form one layer. The adhesion-promoting component is therefore contained in one or more of the water vapor-impermeable layer(s). In this case, the polymers mentioned in the preceding paragraph are again preferred as a component of the layer. Optionally, one or more of the polymers mentioned in the paragraph on the water vapor-blocking layer can be admixed. The layer can optionally also contain additives as mentioned above.

The casing according to the invention generally has 3, 4, 5, 6, 7, 8, or 9 layers. Casings having 5 or 7 layers are preferred.

The subject matter of the invention is also a method for producing the food casing according to the invention. The production is generally carried out by extrusion methods which are known per se to a person skilled in the art.

Firstly, a compound is produced from at least one aliphatic (co-)polyamide and at least one hydrophilic (co-)polymer and possibly additives. For this purpose, the components are jointly melted in a device suitable for this purpose, preferably a dual-screw kneader (also called a double-shaft extruder) having attached perforated die, air cooling section, and granulator, plasticized, homogenized, and pressed out through the die. The granulated material obtained at the end mixed at room temperature with at least one propellant—this is optionally in the form of a granular masterbatch—and possibly further additives, and subsequently melted again in a further extruder. The formation of the gaseous medium from the propellant begins in the course of the temperature increase in the extruder. As a result of the pressure applied in the extruder, the gas initially remains partially or completely dissolved in the melt.

The extrusion of the last-mentioned mixture preferably does not take place in a single extruder but rather distributed onto two or more similar extruders. The composition of the mixture can be slightly varied per extruder here.

In addition to this or these extruder(s), the method includes two or more further extruders. The above-described components of the further layers are supplied to each of these extruders.

All extruders are connected to a temperature-controlled coextrusion annular die having a number of melt channels corresponding to the number of extruders. If the propellant-containing mixture is distributed onto multiple extruders, the melt flows from these extruders thus enter adjacent melt channels and form adjoining layers. An annular multi-layered melt film exits from the annular gap of this die. During the pressure drop shortly before the exit from the die, the formation and expansion of gas bubbles occurs in the layer(s) charged with propellant. By cooling the melt film, a primary tube having a relatively high wall thickness forms, in which the bubble or foam structure is solidified. The primary tube is subsequently rapidly cooled to freeze the amorphous state of the polymers. It is subsequently then heated again to the temperature required for stretching, for example to approximately 80° C. The tube is then stretched in the longitudinal and transverse directions, which is preferably carried out in one work step. The longitudinal stretching is typically performed with the aid of 2 nip roller pairs at increasing drive speed. The transfer stretching is carried out by a gas pressure acting from the inside on the walls of the tube. The area stretching ratio (this is the product of longitudinal and transverse stretching ratios) is generally approximately 6 to 18, preferably 7 to 15, particularly preferably approximately 8 to 11.

After the stretching, the tube is preferably also heat set. The desired shrinking properties may be set exactly by the degree of the heat setting. Finally, the tube is cooled, laid flat, and wound up. The wall thickness (total thickness) of the casing, determined by microscopic measurement of casing cross sections, is generally approximately 40 to 120 μm, preferably approximately 60 to 100 μm after the stretching and heat setting. The proportion of the foamed layer(s) on the inner side of the casing is generally 30 to 85%, preferably 50 to 75%, in relation to the wall thickness. The diameter of the casing is generally in the range of 60 to 220 mm, preferably of 80 to 170 mm.

The foamed layer(s) can be arranged either on the outer or on the inner surface of the tube structure. In the first case, the application of the food additive or additives to the casing takes place from the outside, for example, by spraying, rolling on, or printing. The surface can subsequently also be dried, for example using hot air. The casing has to be inverted after this to bring the applied side to the inside, so that alter the food is filled, a transfer of the additive or additives can take place thereto.

When the foamed layer(s) is/are positioned on the inner surface of the casing, the application of the food additive(s) accordingly takes place on the inside, preferably by so-called “slug impregnation”. In this case, a liquid preparation of the material/materials is poured into the casing and held in contact with it for several seconds. The casing is subsequently guided through a nip roller pair, to strip off the excess of the liquid which is not absorbed. The casing thus impregnated is wound up again. The method can be operated continuously or discontinuously. In any case, inverting the casing is superfluous. It can be used directly for filling the food. The food casing according to the invention is particularly suitable as an artificial sausage casing, especially for encasing cooked or boiled sausage.

### EXAMPLES

The following examples are used for explanation, but without having limiting character for the scope of the invention. Percentages are weight per cents, if not indicated otherwise or apparent from the context.

The following starting materials were used:

### (Co-)polyamides

PA1 polyamide 6/66 having a relative viscosity of 3.4 (measured in 96% sulfuric acid) and a crystallite melting temperature of 192° C. (measured via DSC) (ULTRAMID® C33 N, BASF SE)
PA2 polyamide 6 having a relative viscosity of 4 (measured in 96% sulfuric acid) and a crystallite melting temperature of 220° C. (measured via DSC) (ULTRAMID® B40 N, BASF SE)
PA3 dry blend of polyamide (approximately 88%), polyamide 6-I/6-T (approximately 10%) and calcium carbonate (approximately 2%) (GRILON® FG40 NL, Ems-Chemie)

### Hydrophilic Polymers

PVP1 polyvinyl pyrrolidone having a K value of 25 and a mean molar mass M_{w} of 34 000 Dalton (KOLLIDON® 25, BASF SE)
PVP2 polyvinyl pyrrolidone having a K value of 12 and a mean molar mass M_{w} of 5000 Dalton (PVP K-12, Ashland industries Europe GmbH)

### Plasticizing Agent

Glycerine 96% purity according to ORB (Deutsches Arzneimittelbuch [German pharmacopoeia])

### Chemical Propellant

TR-MB propellant masterbatch based on wax, containing sodium hydrogen carbonate, citric acid, and nucleation agent (CORDUCEL® ETS 9610, Nemetz Additive Plastic GmbH)

### Polyamide Anti-Blocking Agent

PA-AB masterbatch based on polyamlde 6 and calcium carbonate (5015-FT72, PolyOne Colour and Additives Germany GmbH)

Polyolefin/Polymer Having Water Vapor-Blocking Character

PO1 low density polyethylene (LDPE) having a density of 0.923 g/cm³ and an MFI (melt flow index) of 2.0 g/10 min, measured at 2.16 kg load and 190° C. (LD100 BW, ExxonMobil)

### Olefin Copolymer

PO2 ethylene-methacrylic acid copolymer (9.5 wt. % methacrylic acid) having an MFI of 1.3 g/10 min, measured at 2.16 kg load and 190° C. (NUCREL® 31001, DOW)

### Polyolefin Anti-Blocking Agent

PO-AB masterbatch based on polyethylene LLDPE and calcium carbonate (CESA-Block 1101 from Clariant Masterbatches Deutschland GmbH)
Adhesion Promoters/Polymer with Adhesive Properties with Respect to Polyamide
PO-HV low-density linear polyethylene (LLDPE), grafted with maleic acid anhydride (MAA) having a density of 0.928 g/cm³ and having an MFI of 3.0 g/10 min, measured at 2.16 kg load and 190° C. (Yparex™ 9403, The Compound Company BV).

### Measured Variables for Characterizing the Casings

Porosity

The total porosity was ascertained according to the above-described method “volumetric porosity determination”.
Visual Assessment

For the visual assessment, wound casing material was coated on the side of layer 1 (outside) via gravure printing methods.

For example, formulations of paints, and also mixtures of preferably polar liquid smoke types can be used for the coating.

A mixture of liquid smoke types was used here for the coating. The application to the casing surface took place in the flat state on one side by means of a rasterized gravure printing cylinder. Directly after the coating, the casing was guided through a drying channel, through which conditioned air flowed at a temperature of approximately 60° C. The dried casing was subsequently coated in the same way on the rear side, dried, and wound up again. Sample pieces which had been cut out at intervals of several meters were assessed.

The assessment took place on the basis of (a) the visual appearance of the coated surface and (b) an image-analytical determination of the brown-coloured surface proportion in relation to the total surface. A high proportion of coloured surface indicates both a high degree of absorption of the food additive and also a relatively uniform occupancy of the surface therewith.

For the image analysis (b), firstly microscopic incident light pictures of the coated surface were produced of 4 sample sections per example. A light microscope of the type Olympus BX60 with attached digital camera of the type Hitachi HV-C20 was used. All pictures were produced under uniform illumination of the samples with incident light and with uniform camera settings. A detail having the dimensions 1400×1200 μm was used for the analysis from each image.

The image analysis took place with the aid of the software ColorAnalysis, DATINF® GmbH, Tübingen. This software permits, after prior selection of colour values for an object and for the object surroundings, a calculation of the object area in relation to the total area made up of objects and object surroundings. The software first converts for each pixel of the camera image its RGB values into HSV coordinates. (To understand the HSV colour space, see: https://de.wikipedia.org/wiki/HSV-Farbraum. The value H denotes the angle in a colour circle, S defines the colour saturation, and V defines the brightness of the colour tone.) The or colour tones for object and surroundings are also converted into HSV values. Subsequently, the HSV values are converted into Cartesian coordinates. The software thereupon ascertains for each image pixel the respective lesser square of the distance (divided by 0.01% weighting) to the object colour or to the surroundings colour and outputs the pixel numbers which were assigned to each of these colours as percentage values.

For all image analyses, the following selected colours were chosen uniformly:

object colour H=32 surroundings colour H=180 S=98 (medium brown) S=94 (white) V=52 V=100

The averaged area proportions from 4 images for each example are indicated in Table 5.

Example 1 (according to the invention) and example V1 (comparison): production of compounds from aliphatic co-polyamide and hydrophilic polymer.
In a dual-screw extruder (producer Coperion, screw diameter 25 mm) with single-hole exit die, the components listed in Table 1 were supplied sequentially via three discretely arranged metering devices. The metering speeds [mass per unit of time] are in a ratio to one another corresponding to the percentage values indicated in the table. The extruder was temperature controlled to 180° C. at the supply point of the polyamide. In the subsequent housing zones, the temperature control was increased step-by-step to at most 230° C. The screw speed was approximately 200 rpm. In this way, the polyamide was melted and plasticized with the powdered PVP and the glycerine to form a homogeneous mixture. The mixture exited via the perforated die from the extruder as a water-clear, uniform strand. The strand was guided through a water bath for cooling and subsequently crushed to form granulated grains by means of a strand shredder. The granulated material was dried in the recirculating air dryer at approximately 100° C.

TABLE 1
Components of the compounds

| | Name of | Aliphatic | Hydrophilic | Plasticizing |
|---|---|---|---|---|
| Example | compound | polyamide | polymer | agent |
| 1 | Comp1 | PA1 | PVP1 | Glycerine |
| | | 75.5 wt. % | 21 wt. % | 2.7 wt. % |
| V1 | Comp2 | PA1 | PVP2 | Glycerine |
| | | 75.5 wt. % | 21 wt. % | 2.7 wt. % |

### Examples 2 and 3: Production of Biaxially Stretched Tubular Casings Having Foamed Layers

A coextrusion facility according to the prior art was used to produce the casings. The coextrusion facility is equipped with 7 extruders, from each of which melt pumps calibrated for mass throughput were connected downstream, a 7-layer annular die having 60 mm ring diameter, a pipe calibration system, a downstream stretching zone for biaxial bubble stretching, an adjoining heat setting zone, and finally a tube winding unit (so-called double bubble facility).

The 7 extruders were attached to the die such that the melt flow exiting from extruder 1 formed the channel forming the outer layer and the flow from extruder 7 formed the inner layer of the channel forming the 7-layer tube. The other extruders were attached to the die channels corresponding to the extruder numbering.

The granulated materials or granulated material premixes according to Table 2 were supplied via typical metering devices to the 7 extruders, melted therein, plasticized, and conveyed in the direction of the die. The temperature control of the extruders moved in each case in the range between 100 and 240° C. (rising upstream). The die was temperature controlled to 235° C. The propellant proportionally supplied to extruders 1 to 3 successively split off gas due to the elevated temperatures in the melt flows. During the pressure drop upon exiting of the melt film from the die, foaming of the corresponding layers 1, 2, and 3 took place. The melt film was formed via the pipe calibration system into a preliminary tube of 32 mm diameter and solidified. In the stretching zone, the tube was then biaxially stretched by a factor of 8.05, subsequently guided through the heat setting zone, laid flat, and wound up. The resulting casings had a calibre of 104 mm and a shrinkage (measured after laying for 15 minutes in 80° C. hot water) of 6 to 10%, in each of the longitudinal and transverse directions. The total thickness of the casings was not precisely measurable mechanically due to their foamed, porous surfaces. The thicknesses of the layers calculated gravimetrically (“pure thicknesses”) and the resulting total pure thicknesses of the casings (expansion by foaming unconsidered) are indicated.

TABLE 2
Structure of the casings according to
examples 2 and 3 (according to the invention)

| | | | Pure | Pure thickness |
|---|---|---|---|---|
| | | | thickness | of the overall |
| Example | | | single layer ¹⁾ | structure ¹⁾ |
| number | Layer | Composition [wt. %] | [μm/%] | [μm] |
| 2 | 1 | Comp1 [87], PA-AB [9], | 4.2/7.2 | 58.4 |
| | | TR-MB [4] | | |
| | 2 | Comp1 [87], PA-AB [9], | 4.3/7.4 | |
| | | TR-MB [4] | | |
| | 3 | Comp1 [87], PA-AB [9], | 15.1/25.8 | |
| | | TR-MB [4] | | |
| | 4 | PO-HV [100] | 2.4/4.1 | |
| | 5 | PA1 [30], PA2 [70] | 22.6/38.7 | |
| | 6 | PO-HV [100] | 2.4/4.1 | |
| | 7 | PA3 [100] | 7.4/12.7 | |
| 3 | 1 | Comp1 [87], PA-AB [9], | 4.0/6.9 | 58.2 |
| | | TR-MB [4] | | |
| | 2 | Comp1 [87], PA-AB [9], | 4.5/7.7 | |
| | | TR-MB [4] | | |
| | 3 | Comp1 [87], PA-AB [9], | 14.8/25.4 | |
| | | TR-MB [4] | | |
| | 4 | PO-HV [100] | 2.5/4.3 | |
| | 5 | PA1 [30], PA2 [70] | 22.1/38.0 | |
| | 6 | PA1 [30], PA2 [70] | 3.5/6.0 | |
| | 7 | PA3 [100] | 6.8/11.7 | |

¹⁾ effect of the foaming not considered

Comparative examples V2 to V5:

Multi-layered, biaxially stretched casings were produced by means of the described coextrusion facility under the same conditions as in examples 2 to 3. Composition of the layers and casing structures are shown in Table 3.

TABLE 3
Structure of the casings according to comparative examples V2 to V5.
(Not according to the invention)

| | | | Pure | Pure thickness |
|---|---|---|---|---|
| | | | thickness | of the overall |
| Example | | | single layer ¹⁾ | structure ¹⁾ |
| number | Layer | Composition [wt. %] | [μm/%] | [μm] |
| V2 | 1 | Comp2 [87], PA-AB [9], | 4.0/6.9 | 58.1 |
| | | TR-MB [4] | | |
| | 2 | Comp2 [87], PA-AB [9], | 4.2/7.2 | |
| | | TR-MB [4] | | |
| | 3 | Comp2 [87], PA-AB [9], | 14.2/24.4 | |
| | | TR-MB [4] | | |
| | 4 | PO-HV [100] | 2.6/4.5 | |
| | 5 | PA1 [30], PA2 [70] | 22.8/39.3 | |
| | 6 | PO-HV [100] | 2.6/4.5 | |
| | 7 | PA3 [100] | 7.7/13.2 | |
| V3 | 1 | PO1 [87], PO-AB [9], | 3.8/6.3 | 60.0 |
| | | TR-MB [4] | | |
| | 2 | PO1 [87], PO-AB [9], | 3.5/5.8 | |
| | | TR-MB [4] | | |
| | 3 | PO1 [87], PO-AB [9], | 12.5/20.8 | |
| | | TR-MB [4] | | |
| | 4 | PO-HV [100] | 2.7/4.5 | |
| | 5 | PA1 [30], PA2 [70] | 26.7/44.5 | |
| | 6 | PO-HV [100] | 2.3/3.8 | |
| | 7 | PA3 [100] | 8.5/14.2 | |
| V4 | 1 | PA3 [87], PA-AB [9], | 4.5/7.5 | 59.9 |
| | | TR-MB [4] | | |
| | 2 | PA3 [87], PA-AB [9], | 4.6/7.7 | |
| | | TR-MB [4] | | |
| | 3 | PA3 [87], PA-AB [9], | 15.2/25.4 | |
| | | TR-MB [4] | | |
| | 4 | PO-HV [100] | 2.8/4.7 | |
| | 5 | PA1 [30], PA2 [70] | 23.1/38.6 | |
| | 6 | PO-HV [100] | 2.5/4.2 | |
| | 7 | PA3 [100] | 7.2/12.0 | |
| V5 | 1 | PO2 [87], PO-AB [9], | 4.4/7.5 | 58.8 |
| | | TR-MB [4] | | |
| | 2 | PO2 [87], PO-AB [9], | 4.3/7.3 | |
| | | TR-MB [4] | | |
| | 3 | PO2 [87], PO-AB [9], | 15.1/25.7 | |
| | | TR-MB [4] | | |
| | 4 | PO-HV [100] | 2.6/4.4 | |
| | 5 | PA1 [30], PA2 [70] | 22.8/38.8 | |
| | 6 | PO-HV [100] | 2.4/4.1 | |
| | 7 | PA3 [100] | 7.2/12.2 | |

¹⁾ effect of the foaming not considered

All casings according to the examples were coated using the food additive under uniform conditions, as described above.

The properties ascertained on samples from the examples are listed in following Tables 4 and 5.

TABLE 4
Porosity values of the casings according
to the invention and the casings from
comparative examples

| | Sum of pure | Volume sum | |
|---|---|---|---|
| | volumes of | of layers 1 | Average |
| | the layers 1 | to 3 per | total |
| | to 3 per unit | unit of | porosity |
| | of area ¹⁾ | area ²⁾ | of layers |
| | V_{R 1-3} [μm³/ | V₁₋₃ [μm³/ | 1 to 3 ³⁾ |
| Example | μm²] | μm²] | Φ₁₋₃ [%] |
| 2 | 23.6 | 67 | 65 |
| 3 | 23.3 | 61 | 62 |
| V2 | 22.4 | 42 | 47 |
| V3 | 19.8 | 30 | 34 |
| V4 | 24.3 | 35 | 39 |
| V5 | 23.8 | 59 | 60 |

1) value corresponds to the sum of the pure thicknesses of layers 1, 2, and 3 (see Table 3);

2) value corresponds to the sum of the thicknesses of the foamed layers, these are ascertained by measuring microscopic pictures of casing cross sections;

3) calculated according to described method “volumetric porosity ascertainment”.

TABLE 5
Visual assessment of the surfaces of casings according to the invention
coated using food additives and coated casings from comparative examples

| | | Area proportion | Area proportion |
|---|---|---|---|
| | | object colour | surroundings |
| Example | Visual appearance | (brown) [%] | colour (white) [%] |
| 2 | Surface and cavities completely coloured, | 83.9 | 16.1 |
| | homogeneous colour impression | | |
| 3 | Surface and cavities completely coloured, | 79.2 | 19.8 |
| | homogeneous colour impression | | |
| V2 | Surface and cavities coloured, cavities large and | 50.5 | 49.5 |
| | uneven, somewhat ″turbulent″ colour impression | | |
| V3 | Dark, round coloured spots, strongly ″speckled″ | 17.2 | 82.8 |
| | colour impression | | |
| V4 | Cavities coloured, intermediate regions white, | 21.3 | 78.7 |
| | slightly inhomogeneous colour impression | | |
| V5 | Cavities partially coloured, intermediate regions | 19.9 | 80.1 |
| | white, clearly inhomogeneous colour impression | | |

The high values of the total porosity, the homogeneity of the visual appearance, and the high area proportion of the object colour in examples 2 and 3 prove the superiority of the casing according to the invention over the prior art.

That which is claimed:

1. A coextruded, water vapor-impermeable, tubular, seamless food casing having at least three layers, comprising:
at least one porous layer, wherein one of the porous layers forms a surface layer that faces toward a food,
at least one carrier layer based on at least one aliphatic and/or partially aromatic (co-)polyamide, and
at least one water vapor-impermeable layer, wherein either
at least one adhesive layer comprising an adhesion-promoting component is arranged between the adjoining layers or
the adhesion-promoting component is contained in one or more of the water vapor-impermeable layer(s),
characterized in that
at least one porous layer comprises an aliphatic (co-)polyamide and a hydrophilic (co-)polymer having a mean molar mass M_{w} of at least 8000 Da,
wherein the proportion of the hydrophilic (co-)polymer in the porous layer is 3 to 40 wt. %, by weight of the respective porous layer.

2. The food casing according to claim 1, wherein at least one porous layer has a total porosity Φ in the range of 5 to 80 vol. %, wherein Φ is ascertained according to the described method “volumetric porosity determination”.

3. The food casing according to claim 2, wherein at least one porous layer has a total porosity Φ in the range of 10 to 75 vol. %, wherein Φ is ascertained according to the described method “volumetric porosity determination”.

4. The food casing according to claim 1, wherein the aliphatic (co-)polyamide of the at least one porous layer and/or the at least one carrier layer comprises poly(ε-caprolactam) (PA 6), copolymers of ε-caprolactam and ω-laurin lactam (PA 6/12), copolymers of ε-caprolactam, hexamethylene diamine, and adipic acid (PA6/66), and terpolymers of ε-caprolactam, 3-aminomethyl-3,5,5-trimethylcyclohexylamine (isophorone diamine) and/or isophthalic acid.

5. The food casing according to claim 1, wherein the partially aromatic (co-)polyamide of the at least one carrier layer is a copolymer of hexamethylene diamine, isophthalic acid, and terephthalic acid (PA 6-I/6-T) or a homopolymer of meta-xylylene diamine and adipic acid (nylon-MXD6).

6. The food casing according to claim 1, wherein the proportion of the aliphatic (co-)polyamide(s) in the at least one porous layer is 50 to 95 wt. %, based on the weight of said porous layer.

7. The food casing according to claim 6, wherein the proportion of the aliphatic (co-)polyamide(s) in the at least one porous layer is from 60 to 85 wt. %, based on the weight of said porous layer.

8. The food casing according to claim 1, wherein the hydrophilic (co-)polymer is
polyvinyl alcohol (PVAL), having vinyl alcohol units, preferably a copolymer having units made up of vinyl alcohol and propene-1-ol,
polyvinyl pyrrolidone, preferably a homopolymer made up of N-vinyl-2-pyrrolidone units,
a copolymer made up of or having N-vinyl-2-pyrrolidone units and units of at least one α,β-olefinically unsaturated monomer, preferably vinyl ester, particularly preferably vinyl acetate,
a copolymer made up of units of N-vinyl-2-pyrrolidone and one or more α,β-unsaturated carboxylic acids and/or one or more esters or amides of α,β-unsaturated carboxylic acids, preferably methyl acrylate and acrylamides; or
a copolymer made up of units of N-vinyl-2-pyrrolidone and N-vinylimidazole.

9. The food casing according to claim 1, wherein the proportion of the hydrophilic (co-)polymer in the porous layer is 3 to 40 wt. %, based on the weight of said porous layer.

10. The food casing according to claim 1, wherein the casing further comprises at least one chemical propellant.

11. The food casing according to claim 10, wherein said chemical propellant comprises a citric acid and/or sodium hydrogen carbonate, and/or thermal degradation products of at least one chemical propellant.

12. The food casing according to claim 1, wherein at least one porous layer contains inorganic or organic additives.

13. The food casing according to claim 1, wherein the water vapor-impermeable layer comprises an olefinic (co-)polymer.

14. The food casing according to claim 13, wherein said olefinic (co-)polymer comprises polyethylene (HDPE, LDPE, or LLDPE), ethylene-α-olefin copolymers, polypropylene, an ethylene-propylene copolymer, or a terpolymer made up of various olefins.

15. The food casing according to claim 1, wherein the adhesive layer comprises an olefin-containing polymer.

16. The food casing according to claim 15, wherein said olefin-containing polymer comprises polyethylene or ethylene-α-olefin-copolymer grafted with the anhydride of an α,β-unsaturated dicarboxylic acid, an ethylene/vinyl acetate copolymer, an ethylene/(meth)acrylic acid copolymer or their Na or Zn salt, an ethylene/(meth)acrylic acid ester copolymer, or a corresponding terpolymer.

17. The food casing according to claim 15, wherein said olefin-containing polymer comprises maleic acid anhydride.

18. The food casing according to claim 1, wherein at least one of the further (nonporous) layers contains plastic-typical additives in a proportion of 0.2 to 5 wt. % based on the weight of said layer.

19. A method for producing a food casing according to claim 1, comprising the following steps:
providing a granulated material comprising at least one aliphatic (co-)polyamide, at least one hydrophilic (co-)polymer, and possibly additive(s),
producing one or more mixtures of the obtained granulated material with at least one propellant or at least one propellant masterbatch and possibly further additives;
melting, plasticizing, and homogenizing the mixture or the mixtures in one or more extruder(s);
melting, plasticizing, and homogenizing one or more granulated material/granulated material mixtures for the carrier layer(s) in one or more further extruder(s);
melting, plasticizing, and homogenizing one or more granulated materials/granulated material mixtures for the water vapor-impermeable layer(s) in one or more further extruder(s);
possibly melting, plasticizing, and homogenizing one or more granulated materials/granulated material mixtures for the adhesive layer(s) in one or more further extruder(s);
bringing together the melt flows in a coextrusion annular die and forming them into a seamless multi-layered primary tube;
rapidly cooling the primary tube;
heating the primary tube to approximately 80° C. with subsequent stretching of the primary tube in the longitudinal and transverse directions.

20. An artificial sausage casing for encasing cooked or boiled sausage comprising a food casing according to claim 1.
